(19) United States
(12) Patent Application Publication
(10) Pub. No.: US 2025/0221803 A1
(43) Pub. Date: Jul. 10, 2025

(54) MECHANICAL ENTRAPMENT STRUCTURES AND METHODS OF COATING ADDITIVELY MANUFACTURED OBJECTS USING THE SAME

(71) Applicant: Carbon, Inc., Redwood City, CA (US)

(72) Inventors: R. Nicholas Carmean, Mountain View, CA (US); Kyle Kloster, East Palo Alto, CA (US)

(21) Appl. No.: 19/013,577

(22) Filed: Jan. 8, 2025

Related U.S. Application Data
(60) Provisional application No. 63/639,259, filed on Apr. 26, 2024.
(60) Provisional application No. 63/619,053, filed on Jan. 9, 2024.

(51) Int. Cl. A61C 13/10; A61C 13/00; A61C 13/08; A61C 13/087; B33Y 40/20; B33Y 80/00

(52) U.S. Cl. CPC A61C 13/10; A61C 13/0006; A61C 13/082; A61C 13/087; B33Y 40/20; B33Y 80/00

(57) ABSTRACT

Provided herein are methods of making a coated object that include applying a coating composition to a surface of an object that comprises a plurality of entrapment structures thereon, wherein the coating composition is on at least a portion of the plurality of entrapment structures; and curing and/or solidifying the coating composition to form the coated object. Also provided are coated objects formed by such methods. Additionally, provided herein are methods of bonding a first surface to a second surface wherein the first surface and/or the second surface comprises a plurality of entrapment structures thereon. Composite articles are also provided herein.

### CROSS-REFERENCE TO RELATED APPLICATIONS

This application claims priority to U.S. Provisional Application No. 63/619,053, filed on Jan. 9, 2024, and U.S. Provisional Application No. 63/639,259, filed on Apr. 26, 2024, the disclosures of which are incorporated herein by reference in their entirety.

### FIELD OF THE INVENTION

The present invention relates to additively manufactured parts. The present invention also relates to methods of coating additively manufactured parts.

### BACKGROUND OF THE INVENTION

A group of additive manufacturing techniques sometimes referred to as “stereolithography” create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into a pool of resin.

The introduction of a rapid stereolithography technique sometimes referred to as continuous liquid interface production (CLIP) has expanded the usefulness of stereolithography from prototyping to manufacturing. See e.g., J. Tumbleston, et al., Continuous liquid interface production of 3D objects, Science, 347, 1349-1352; R. Janusziewicz, et al., Layerless fabrication with continuous liquid interface production, PNAS, 113, 11703-11708 (18 Oct. 2016); and U.S. Pat. Nos. 9,211,678, 9,205,601, and 9,216,546.

Protective coatings may be desirable on additive manufactured objects, for example, to increase longevity when the object is exposed to a certain environment, or to provide different properties at the surface than in the bulk of the object. However, certain coatings (e.g., silicone or fluoropolymer coatings) may be difficult to adhere to certain polymer surfaces. While the use of primers may improve adhesion in some cases, they may not be sufficiently effective, and their use typically requires an additional processing step. Accordingly, new methods for coating additively manufactured objects would be desirable.

### SUMMARY OF THE INVENTION

Provided according to embodiments of the present invention are methods of making a coated object that include applying a coating composition to a surface of an object (e.g., an object produced in whole or in part by an additive manufacturing process) that comprises a plurality of entrapment structures thereon, wherein the coating composition is on at least a portion of the plurality of entrapment structures; and curing and/or solidifying the coating composition to form the coated object.

Also provided according to embodiments of the invention are coated objects that include a base object comprising a surface having a plurality of entrapment structures thereon (e.g., a polymeric base object formed by an additive manufacturing process); and a solid coating layer on the base object, wherein the solid coating layer is within and on the plurality of entrapment structures.

In some embodiments of the invention, provided are methods of bonding a first surface to a second surface that include (a) applying an adhesive composition to the first surface and/or the second surface, wherein the first surface and/or the second surface comprises a plurality of entrapment structures thereon, and (b) contacting the first surface to the second surface for a time sufficient to form a bond between the first surface and the second surface, wherein the adhesive composition is on and/or in at least a portion of the plurality of entrapment structures on the first surface and/or second surface.

In some embodiments of the invention, provided are composite articles that include a first object comprising a first surface; a second object comprising a second surface, wherein the first surface and/or the second surface include(s) a plurality of entrapment structures thereon; and an adhesive layer connecting the first surface and the second surface, wherein the adhesive layer encompasses some or all of the entrapment structures.

### BRIEF DESCRIPTION OF THE DRAWINGS

FIG. 1 is an illustration of a surface having discrete loop entrapment structures according to some embodiments of the invention thereon.

FIGS. 2A-2D are illustrations of discrete loop entrapment structures according to some embodiments of the invention.

FIG. 3 is an illustration of a surface having discrete loop entrapment structures according to some embodiments of the invention thereon.

FIGS. 4A-4D are top views of discrete loop entrapment structures according to some embodiments of the invention.

FIG. 5 is an illustration of a surface having discrete loop entrapment structures according to some embodiments of the invention thereon.

FIG. 6A is an illustration of a surface having connected tunnel entrapment structures according to some embodiments of the invention thereon.

FIG. 6B is a magnified view of a portion of a connected tunnel entrapment structure in FIG. 6A.

FIGS. 7A and 7B are illustrations of lattices that may act as connected tunnel entrapment structures according to some embodiments of the invention.

FIG. 8 is an illustration of a surface having a discrete loop entrapment structure thereon and a coating layer in and on the discrete loop entrapment structure according to some embodiments of the invention.

FIG. 9 is an illustration of a first surface having a discrete loop entrapment structure thereon, a second surface on the first surface, and an adhesive composition layer between the first surface and the second surface and in and on the discrete loop entrapment structure according to some embodiments of the invention.

FIG. 10 is an illustration of first and second surfaces each having a discrete loop entrapment structure thereon and an adhesive composition layer between the first and second surfaces and in and on the discrete loop entrapment structure according to some embodiments of the invention.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another clement, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

As used herein, a “plurality” of any element refers to two or more of such elements and may include 10%, 20%, 30%, 40%, 50%, 60%, 70%, 80%, 90%, 95%, 99% or 100%, or any range defined therein, of the total number of elements. For example, a plurality of entrapment structures on a surface or on an object may include two or more entrapment structures on the surface and/or object, or 10%, 20%, 30%, 40%, 50%, 60%, 70%, 80%, 90%, 95%, 99% or 100%, and any range defined therein, of the entrapment structures on the surface and/or object. A plurality of entrapment structures further includes a majority of the entrapment structures (>50%), most of the entrapment structures (>70%, >80%, or >90%), substantially all of the entrapment structures (>95%), or all of the entrapment structures (100%) on a surface and/or on an object.

All patents or published patent applications referenced are herein incorporated by reference in their entirety. In the case of conflicting terminology, the present application controls.

### Coated Objects

Provided according to embodiments of the invention are coated objects that include a base object (or a surface of a base object) having a plurality of entrapment structures thereon; and a solid coating layer on the base object, wherein the solid coating layer is on at least a portion of the plurality of entrapment structures.

The entrapment structures may be configured to entrap the solid coating layer within a portion of the structure when the solid coating layer is adhered to the surface of the base object. In this configuration, the entrapment structures may improve adherence of the solid coating layer to the base object by entrapping portions of the solid coating layer within the entrapment structure and/or providing additional surface area for the solid coating layer to contact and adhere. For example, the entrapment structures may include a void space. Accordingly, when the solid coating layer is applied to the surface of the base object having entrapment structures thereon, the solid coating layer at least partially fills the void space of the entrapment structure and/or contacts the surface(s) of the entrapment structure to provide additional structural support to adhere the solid coating layer to the base object. As such, the solid coating layer is within the void space of the entrapment structures and on a top portion of the entrapment structures so that the entrapment structures are generally below the surface of the solid coating layer and therefore, not present on the surface of the coated object. In some embodiments, the entrapment structures may be sufficiently low profile so as to be covered by the coating on the coated object. The solid coating layer may be on top surfaces of the entrapment structures and, in some embodiments, may provide an outer surface that is devoid of bumps or protrusions from the entrapment structures. The entrapment structures on the surface of the base object may provide improved adherence of the coating layer to the base object as compared to a base object without entrapment structures thereon.

In some embodiments, the base object and the entrapment structures thereon are formed by an additive manufacturing process, as described herein. In some embodiments, an additional processing step to add a primer on the surface of the base object may be omitted; however, embodiments according to the invention are not limited thereto, and in some embodiments, primers may be used with entrapment structures for providing increased adherence of the solid coating layer.

An entrapment structure, as used herein, refers to a surface feature on an object that includes a void space in which a coating may be present and fill or partially fill the void space and/or contact the void space, thereby securing the coating on the surface of the object. In some embodiments, the coating layer is on or directly on at least a portion of both a top side and an opposing bottom side of the entrapment structure. An entrapment structure may be a structure that extends away from a major surface of the base object and further extends over a portion of the surface to form the void space. In some embodiments, the coating layer may be in a region between the entrapment structure and the major surface of the base object. In some embodiments, the plurality of entrapment structures includes discrete loop structures, connected tunnel structures, or a combination thereof. A discrete loop structure may include a loop that extends over the surface of the base object to define the void space between the discrete loop structure and the surface of the base object. A connected tunnel structure may be formed in a structure on the base object to provide a void space or spaces therein that are configured to entrap the coating. For example, as described in greater detail herein, a connected tunnel structure may include apertures or openings configured to receive the coating layer so that the coating layer fills or partially fills the connected tunnel structure. The discrete loop structures and the connected tunnel structures may be considered the two extremes of a spectrum, and the entrapment structure(s) may include any structure between these two extremes. For example, portions of a connected tunnel structure may be omitted to more closely resemble a loop structure or a loop structure may be extended to more closely resemble a tunnel structure.

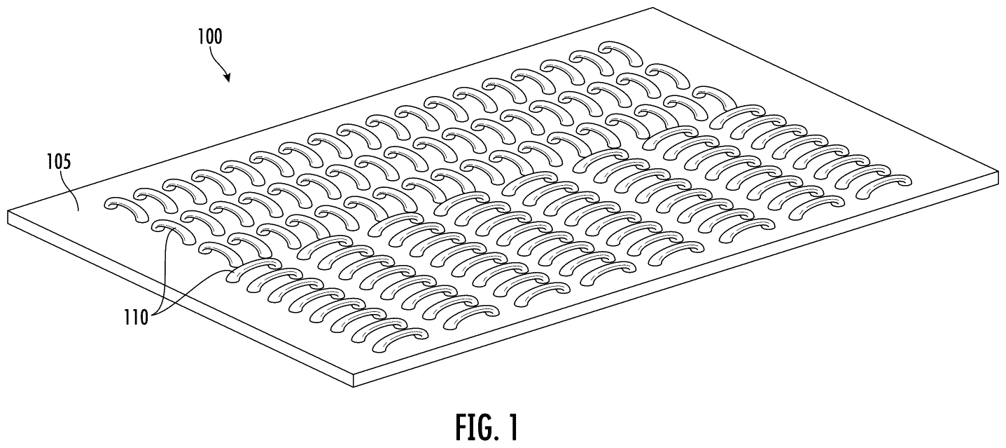

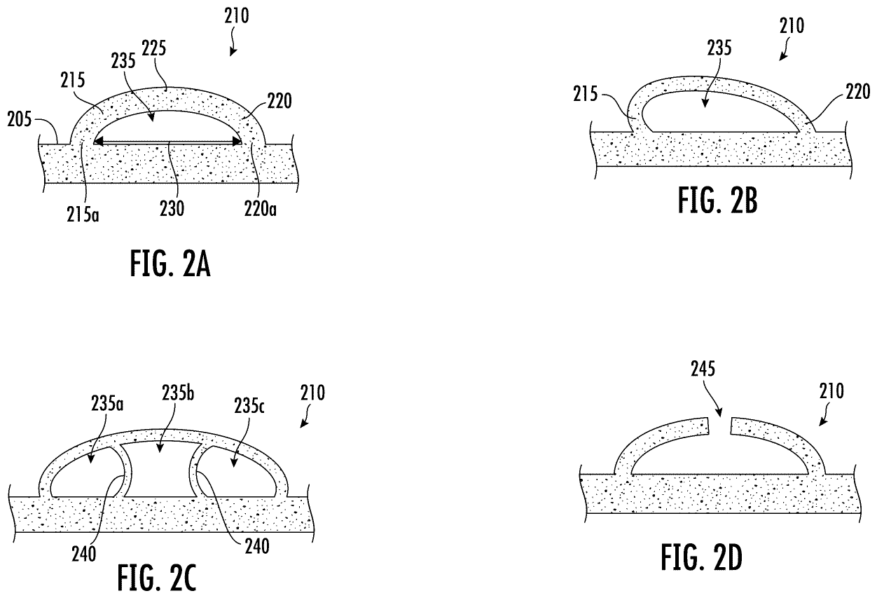

Examples of discrete loop entrapment structures are shown in FIGS. 1-5. As shown in FIG. 1, a plurality of discrete loop structures 110 may be present on a surface 105 of an object 100 and the entrapment structures 110 are simple loops. A magnified sideview of such a discrete loop structure is shown in FIG. 2A. The discrete loop structure 210 on a surface 205 may include a first leg 215 and a second leg 220 when the loop structure 210 is divided at a central point 225. The first leg 215 may be connected to surface 205 at a first attachment point 215a and the second leg 220 may be connected to surface 205 at a second attachment point 220a, creating a void space 235 therebetween. The void space 235 is the empty space between the surface 205 and discrete loop structure 210. The widest portion of the void space 235 is referred to herein as the void space diameter 230, which in FIG. 2A is the distance between the first attachment point 215a and the second attachment point 220a. In some embodiments, at least one entrapment structure, a majority of the entrapment structures, most of the entrapment structures, substantially all of the entrapment structures 210, or all of the entrapment structures on a surface of an object have a void space diameter 230 of about 10 μm, about 20 μm, about 100 μm, about 400 μm, about 500 μm, about 800 μm, about 1000 μm, about 1200 μm, about 1500 μm, or a range defined between any of the foregoing (e.g., about 10 μm to about 100 μm, about 400 μm, about 1000 μm, or about 1500 μm). In some embodiments, for a majority of the entrapment structures, most of the entrapment structures, substantially all of the entrapment structures 210, or all of the entrapment structures 210 on a surface of an object, a void space 235 may have a height of about 10 μm, about 20 μm, about 100 μm, about 400 μm, about 500 μm, about 800 μm, about 1000 μm, about 1200 μm, about 1500 μm, or a range defined between any of the foregoing (e.g., about 10 μm to about 100 μm, about 400 μm, about 1000 μm, or about 1500 μm). The void space dimensions may vary with the viscosity of the coating composition to be applied thereto. As such, in some embodiments, the void space 235 (including the void space diameter 230 and void space height) are sufficiently large that a coating composition may flow into and through a void space 235 in the entrapment structure 210.

Referring to FIG. 2B, the loop structure 210 and/or the void space 235 may or may not be symmetrical and the first leg 215 and the second leg 220 may be of same or different lengths or widths. Referring to FIG. 2C, in some embodiments, there may be internal structures in the void space 235 including one or more support structures 240, resulting in multiple void spaces 235a, 235b, and 235c. Referring to FIG. 2D, in some embodiments, there may be one or more apertures 245 in the discrete loop structures 210. In some embodiments, the apertures 245 are in a range of about 1 μm to about 50 μm, about 100 μm, about 200 μm, about 300 μm, or about 400 μm.

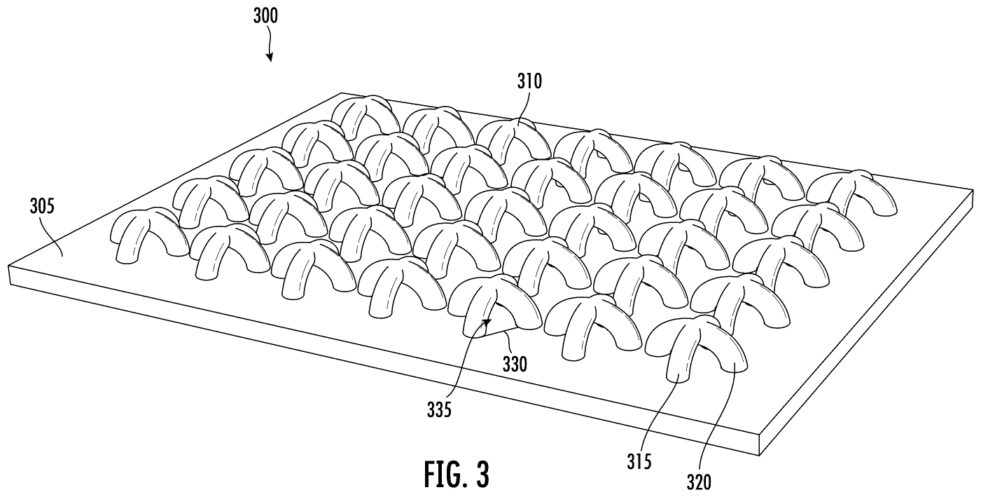

In some embodiments, as shown in FIG. 3, the discrete loop entrapment structure(s) 310 on the surface 305 of the object 300 may include the first leg 315 and the second leg 320 and one or more additional legs. In FIG. 3, two additional legs are present in the loop structures 310 but discrete loop structures 310 may also have 1, 2, 3, 4, 5, 6 or more additional legs, provided that the void space diameter 330 is sufficiently large to allow for a liquid coating composition to sufficiently fill the void space 335.

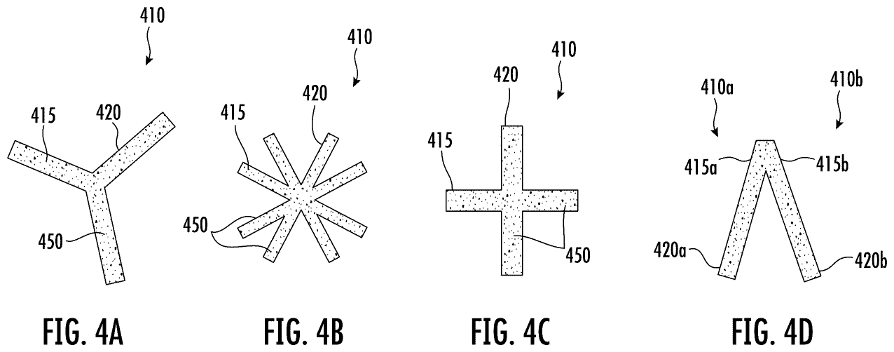

FIGS. 4A, 4B, and 4C are top views of entrapment structures 410 according to some embodiments of the invention. Each entrapment structure 410 includes a first leg 415 and a second leg 420 and at least one additional leg 450. Referring to FIG. 4D, in some embodiments, a first loop structure 410a and a second loop structure 410b are connected, including as shown in FIG. 4D, attaching to the surface (not shown) the same point. FIG. 4D shows a first loop structure 410a that includes a first leg 415a and a second leg 420a and a second loop structure 410b that includes a first leg 415b and a second leg 420b, wherein the first leg 415a of the first loop structure 410a and the first leg 415b of the second loop structure 410b are connected or attached to the same portion of the surface. The first loop structure 410a and the second loop structure 410b may be connected at other positions in certain embodiments.

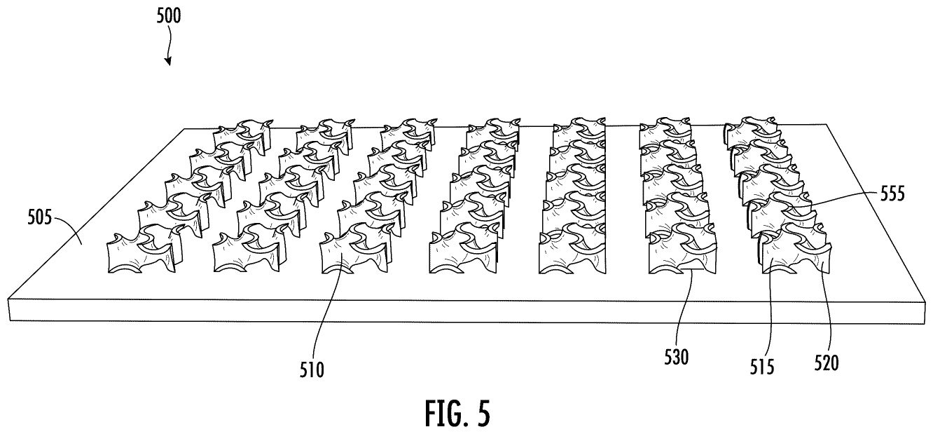

The internal and/or external surfaces of the simple or complex discrete loop entrapment structures may also be varied in size and shape, as shown in FIG. 5. In FIG. 5, the discrete loop entrapment structure(s) 510 on the surface 505 of the object 500 have a first leg 515 and a second leg 520, and additional legs. The width of the loop structures 510 varies along the length of structure and additional features 555 are present on the external surface of the discrete loop entrapment structure(s) 510. In some embodiments, the additional feature(s) 555 may provide additional surfaces for coating entrapment and/or adhesion. In addition, in some embodiments, the legs (e.g., 515, 530) may be complex and may connect to the surface 505 at multiple positions. The coating polymer may flow within at least a portion of the void spaces each entrapment structure 510 so that the coating composition is in, on, and/or penetrates through the entrapment structure(s) 510. Such entrapment structures may include at least one void space 535 having a void space diameter 530 and/or height discussed above with respect to the discrete loop structures.

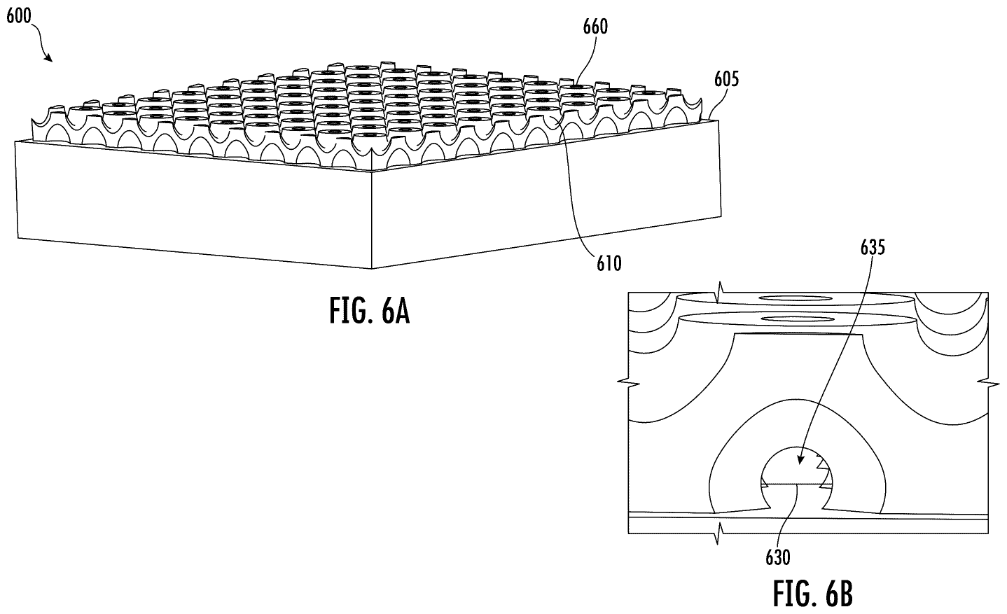

In some embodiments of the invention, one or more entrapment structures may combine to form a connected tunnel structure. The coating polymer may flow within at least a portion of the void spaces in the tunnel structure so that the coating composition is in, on, and/or penetrates through the entrapment structure(s). One example is shown in FIG. 6A. In FIG. 6A, the connected tunnel entrapment structure 610 is present on a surface 605 of an object 600. In some embodiments, the void space 635 of the connected tunnel entrapment structure 610 may have a void space diameter 630 of about 10 μm, about 20 μm, about 100 μm, about 400 μm, about 500 μm, about 800 μm, about 1000 μm, about 1200 μm, about 1500 μm, or a range defined between any of the foregoing. There may be multiple void space diameters 630 in the connected tunnel structure 610 and the shape of the void space 635 and the void space diameter 630 may vary throughout the connected tunnel structure 610. The connected tunnel entrapment structure(s) 610 may also include one or more apertures 660 on the surface of the connected tunnel structure 610. In some embodiments, such apertures 660 may be sufficiently large for a coating composition to flow therethrough. In addition, the connected tunnel 610 may have at least one void space 535, including a tunnel through the entrapment structure 610, having a void space diameter 630 and/or void space height discussed above with respect to the discrete loop structures.

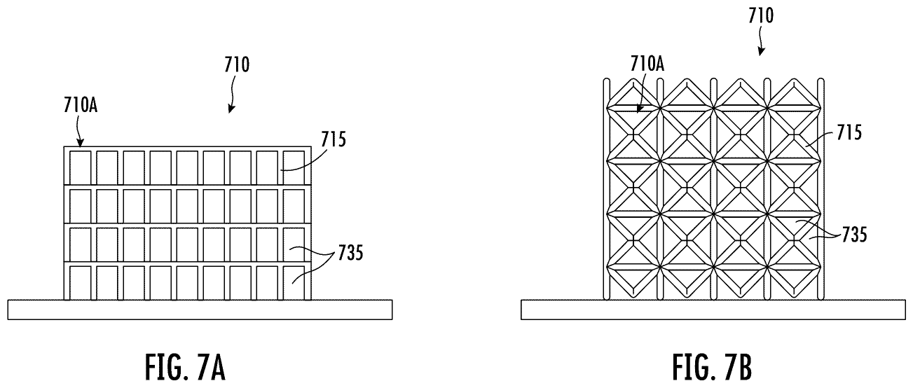

In some embodiments, the connected tunnel structure may be in the form of a lattice such as shown in FIGS. 7A and 7B. A lattice may comprise a repeating unit cell pattern. As illustrated in FIGS. 7A and 7B, the entrapment structure 710 is formed from a plurality of legs or struts 715, which form a unit cell 710A. Any suitable lattice structure may be used as the entrapment structure 710 provided that the void spaces 735 therein are sufficiently large so that the coating composition can fill the void spaces 735. Examples of lattice structures include but are not limited to tetrahedral, octahedral, rhombic, star, Kagome, Voroni, and honeycomb (with or without apertures) but any lattice that may act as an entrapment structure (having a coating therein and thereon) may be used as a connected tunnel entrapment structure 710. In such cases, the strut diameter and spacing should be such that a coating composition may penetrate into, on, and through the lattice.

Lattice structures are known and described in, for example, U.S. Patent Publication Nos. 20210246959; 20220143917; and 20220386733, and in U.S. Pat. Nos. 10,384,394; 10,744,711; 11,167,395; and 11,292,186.

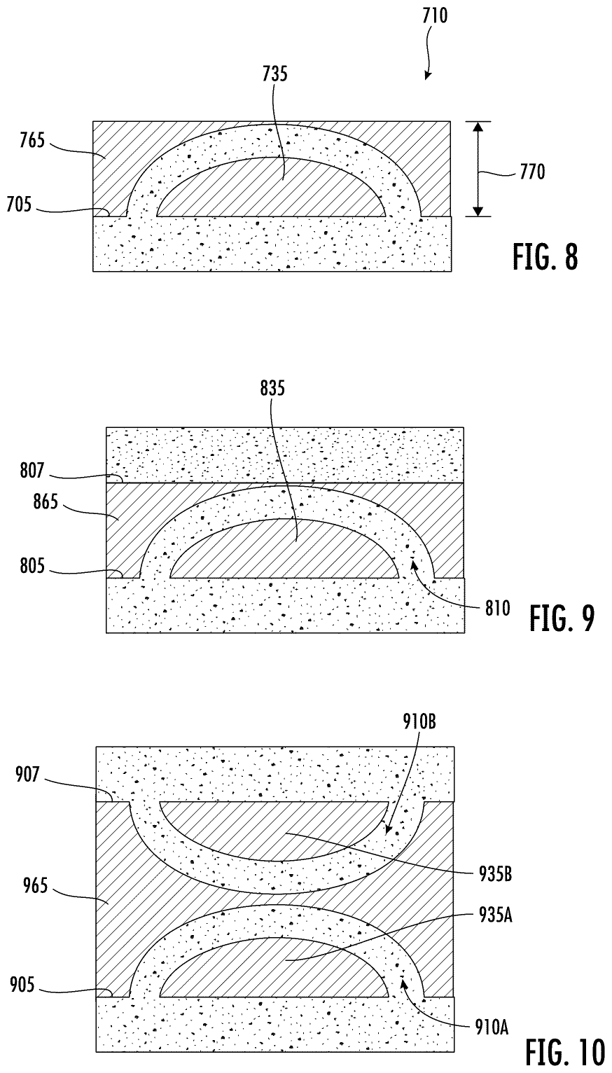

The coated objects of the invention include a solid coating on the surface of the base object, whereby the solid coating encapsulates the entrapment structures, such that the coating is within the void space(s) of the entrapment structures and on the entrapment structure. In some embodiments, the entrapment structures may be sufficiently low profile and sized and configured so as to be covered by the coated object. Referring to FIG. 8, a coating layer 765 may be on the surface 705 of an object, encapsulating the entrapment structure(s) 710. In general, the coating composition fills all the void space 735 in the entrapment structure(s) 710, but in some embodiments, the coating is present in 50%, 60%, 70%, 80%, 90%, 95%, 99%, 100%, or any range defined between the foregoing values, of the void space 735 of the entrapment structure(s) 710. In particular embodiments, the height of the entrapment structures 710 (including discrete loop structures and connected tunnel structures) about 10 μm, about 20 μm, about 100 μm, about 400 μm, about 500 μm, about 800 μm, about 1000 μm, about 1200 μm, about 1500 μm, or a range defined between any of the foregoing (e.g., about 10 μm to about 100 μm, about 400 μm, about 1000 μm, or about 1500 μm). Accordingly, in particular embodiments, the coating layer 765 may have a thickness 770 in a range of 150 μm to 500 μm, 1000 μm, 1500 μm, 2000 μm, 5000 μm, or more, or in some embodiments, the coating layer is 10 μm, 20 μm, 50 μm, 100 μm, 200 μm (or more) higher than the top of the entrapment structure. Accordingly, in some embodiments, the coating layer 765 is on a top surface of the entrapment structure(s) 710 and provides an outer surface of the object that is devoid of bumps or protrusions from the entrapment structures. In particular embodiments, the outer surface may be smooth or planar.

The base object and entrapment structures may be formed of any suitable polymer (or other material used in additive manufacturing including ceramic and metals) used in additive manufacturing. Further, while the base object and the entrapment structures are typically formed of the same polymer as they are typically manufactured during the same additive manufacturing process, in some embodiments, the entrapment structures may be formed of a different polymer or material type than the base object. In some embodiments, the object and/or the entrapment structures are formed from an elastomeric polymer including but not limited to a silicone, epoxy, acrylate, methacrylate and/or a polyurethane. In some embodiments, the object and/or entrapment structures are formed from a rigid polymer. In some embodiments, the object and/or entrapment structures are made from a resin described below.

The solid coating layer may also be formed of a number of suitable polymers. In some embodiments, the coating layer comprises a silicone, a polyurethane, and the like. In particular examples, the coating is omniphobic. The coating layer may also include a number of additives, as described below. Although embodiments according to the invention are described with respect to a solid coating layer, it should be understood that the coating layer may be applied as a fluid and then cured to form a solid coating layer.

### Methods of Making Coated Objects

Provided according to embodiments of the invention are methods of making an object having a surface coating bonded thereto. Such methods include applying a coating composition to a surface of a base object (e.g., an object produced in whole or in part by an additive manufacturing process), wherein the surface includes a plurality of entrapment structures thereon and wherein the coating composition envelopes or is on at least a portion of the plurality of entrapment structures. Such methods may further include curing and/or solidifying the coating composition to form the coated object.

In some embodiments, the coating composition comprises at least one additive selected from a matting agent, a gloss control agent, a UV blocker, an IR blocker, an optical brightener, an antioxidant, a flow control agent, a dispersant, a thixotropic agent, a dilatant, an adhesion promoter, flame retardant, a slip additive, an anti-slip additive, a texturing additive, an oil resistance additive, a water resistance additive, a chemical resistance additive, an antimicrobial agent (including an antibacterial agent), an antiviral agent, a nylon filler, a wax additive, and combinations thereof.

In some embodiments, the coating composition comprises from about 1 or about 2 percent by weight to about 20, about 50 or about 80 percent by weight, of a pigment, a matting agent, or a combination thereof. In some embodiments, the pigment includes color pigment particles, effect pigment particles (e.g., metallic or pearlescent particles), or a combination thereof. In some embodiments, the pigment includes pigment particles having an average diameter in a range of from about 10 or about 20 nanometers to about 0.1, about 0.5, about 1 or about 2 micrometers.

Resins for additive manufacturing of polymer objects are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc. Any suitable resin may be used to form the parts or polymer lattices of the invention, including single cure, dual cure, elastomer-forming resins, and thermoset-forming resins.

### Additive Manufacturing Methods, Apparatus and Resins

Objects of the invention, as described above, may be made by an additive manufacturing processes that include the steps of: (a) providing a digital model of the object including the entrapment structures thereon; and then (b) producing that object and entrapment structures from the digital model by an additive manufacturing process.

Numerous additive manufacturing processes are known. Suitable techniques include, but are not limited to, techniques such as selective laser sintering (SLS), fused deposition modeling (FDM), stereolithography (SLA), material jetting including three-dimensional printing (3DP) and multijet modeling (MJM) (MJM including Multi-Jet Fusion such as available from Hewlett Packard), and others. See, e.g., H. Bikas et al., Additive manufacturing methods and modelling approaches: a critical review, Int. J. Adv. Manuf. Technol. 83, 389-405 (2016).

Stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewicz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

In some embodiments, the object is an intermediate object formed using a dual cure resin and the object is heated and/or microwave irradiated before and/or after applying the coating composition. After the object is formed, it is typically cleaned (e.g., by washing, centrifugal separation, wiping, blowing, etc.), and in some embodiments then further cured, such as by baking (although further curing may in some embodiments be concurrent with the first cure, or may be by different mechanisms such as contacting to water, as described in U.S. Pat. No. 9,453,142 to Rolland et al.). Such post-processing steps (curing, washing, etc.) may also be performed to the coated object.

### Uses and Applications

The coated objects of the invention as described herein have a variety of uses. They can serve as a cushion, shock absorber, vibration isolator, handle, sound dampening layer, protective pad. In some embodiments they can be configured as a heat exchanger (i.e., connected to a heat source such as an electrical, opto-electrical, or electromechanical device, to serve as a heat sink).

The foregoing is illustrative of the present invention and is not to be construed as limiting thereof. The invention is defined by the following claims, with equivalents of the claims to be included therein.

### Bonding Surfaces Including Entrapment Structures

In some embodiments of the invention, entrapment structures, as described herein, may be used to increase the strength of an adhesive bond between two surfaces. Accordingly, in some embodiments, provided are methods of bonding a first surface to a second surface. Such methods include (a) applying an adhesive composition to the first surface and/or the second surface, wherein the first surface and/or the second surface comprises a plurality of entrapment structures thereon, and (b) contacting the first surface to the second surface for a time sufficient to form a bond between the first surface and the second surface, wherein the adhesive composition is on and/or in at least a portion (some or all) of the entrapment structures on the first surface and/or second surface. Additional surfaces (e.g., third, fourth, fifth, etc.) may also be bonded to the first and/or second surface. The entrapment structures may be on all, some, or only one of the surfaces being bonded. In addition, adhesive may be applied to one, some, or all of the surfaces being bonded. In some embodiments, the first surface will be part of a first object and the second surface will be part of a second object and so bonding the first surface to the second surface will form a bond between the first object and the second object. However, in some embodiments, the first surface and second surface are part of the same object.

Referring to FIG. 9, a first surface 805 of a first object and a second surface 807 of a second object are bonded together by an adhesive layer 865. An entrapment structure 810 having a void space 835 is on the first surface 805, and the adhesive layer 865 encapsulates the entrapment structure 810 and forms a bond between the first surface 805 and the second surface 807.

It should be understood that the entrapment structures may be on one or both surfaces bonded together by the adhesive composition layer. For example, FIG. 10 illustrates a first surface 905 of a first object and a second surface 907 of a second object, which are bonded together by an adhesive layer 965. Entrapment structures 910A and 910B with corresponding void spaces 935A and 935B are on the first and second surfaces 905 and 907, respectively. The adhesive layer 965 encapsulates the entrapment structures 910A and 910B and forms a bond with the first surface 905 and the second surface 907. Although the entrapment structures 910A and 910B are illustrated as being aligned with one another, in some embodiments, the entrapment structures 910A and 910B are misaligned or staggered. If the entrapment structures 910A and 910B are misaligned, the thickness of the adhesive layer 965 may be reduced.

The entrapment structures 810, 910A, 910B may be formed as described herein with respect to entrapment structures described in FIGS. 1-8 and the adhesive layers 865, 935 may be sized and configured similarly to the coating layers described with respect to FIGS. 1-8.

The adhesive composition may include any liquid composition that solidifies after drying and/or curing. Accordingly, the coating compositions described herein may be used as adhesives in some embodiments. Other adhesive compositions, including those known in the art including but not limited to epoxy, silicone, acrylic, cyanoacrylates, urethanes, and the like, may be used. Physical processes including, but not limited to, applying heat, irradiation, and/or moisture to the adhesive and/or objects to facilitate bonding may also be used prior to, during, and/or after the adhesive bond formation.

The objects to be bonded may be formed of any material and may include one or more different materials, including one or more polymers. Any suitable polymer may be used, including elastomeric polymers (e.g., silicones or polyurethanes) or rigid polymers. Any type of object(s) may be used as well. For example, in some embodiments, the first object is a denture base, and the second object is a prosthetic tooth. In some embodiments, the first surface and/or second surface is part of intermediate object(s) formed using a dual cure resin and the intermediate object(s) may be heated, microwave irradiated, and/or moisture cured before, during, and/or after bonding the first surface to the second surface.

Any of the entrapment structures and configurations of entrapment structures described herein may be used in bonding two or more surfaces. For example, in some embodiments, the plurality of entrapment structures includes discrete loop structures, connected tunnel structures, or a combination thereof.

Using the bonding methods described herein, composite articles of the invention may be formed. Accordingly, in some embodiments, provided are composite articles that include a first object comprising a first surface; a second object comprising a second surface, wherein the first surface and/or the second surface include(s) a plurality of entrapment structures thereon; and an adhesive layer connecting the first surface and the second surface, wherein the adhesive layer encompasses (is in and around) some or all of the entrapment structures. Additional objects and/or surfaces may be bonded to the first and/or second object in some composite articles. In some embodiments, provided is a single object that includes a first surface and a second surface, wherein the first surface and/or the second surface include(s) a plurality of entrapment structures thereon; and an adhesive layer connecting the first surface and the second surface, wherein the adhesive layer encompasses (is in and around) some or all of the entrapment structures. Additional surfaces may be bonded to the first and/or second surface. While a wide variety of composite articles are envisioned, in some embodiments, the composite article is a denture base having a prosthetic tooth bonded thereto.

1. A method of making a coated object, comprising:
applying a coating composition to a surface of an object produced in whole or in part by an additive manufacturing process that comprises a plurality of entrapment structures thereon, wherein the coating composition is on at least a portion of the plurality of entrapment structures; and
curing and/or solidifying the coating composition to form the coated object.

2. The method of claim 1, wherein the plurality of entrapment structures comprises discrete loop structures, connected tunnel structures, or a combination thereof.

3. The method of claim 1, wherein the object is formed from an elastomeric polymer.

4. The method of claim 1, wherein the coating composition comprises from about 1 or about 2 percent by weight to about 20, about 50 or about 80 percent by weight, of a pigment, a matting agent, or a combination thereof.

5. (canceled)

6. The method of claim 4, wherein the pigment comprises pigment particles having an average diameter in a range of from about 10 or about 20 nanometers to about 0.1, about 0.5, about 1 or about 2 micrometers.

7. The method of claim 1, wherein the coating composition comprises at least one additive selected from a matting agent, a gloss control agent, a UV blocker, an IR blocker, an optical brightener, an antioxidant, a flow control agent, a dispersant, a thixotropic agent, a dilatant, an adhesion promoter, a slip additive, an anti-slip additive, a texturing additive, an oil resistance additive, a water resistance additive, a chemical resistance additive, an antimicrobial agent, an antibacterial agent, an antiviral agent, a nylon filler, a wax additive, and a combination of two or more of the foregoing.

8. The method of claim 1, wherein the coating composition comprises a polymer and/or a precursor for forming a polymer selected from the group consisting of a silicone, a fluoropolymer, a fluorosilicone, a nitrile, and a polyurethane, optionally wherein the polymer is omniphobic.

9. (canceled)

10. The method of claim 1, wherein the plurality of entrapment structures comprise discrete looped structures.

11. The method of claim 1, wherein the plurality of entrapment structures comprise connected tunnel structures.

12. The method of claim 1, wherein each of the entrapment structures comprises a void space having a diameter of about 10 μm to about 1500 μm, and the coating composition is in the void space.

13. A coated object comprising:
a base object comprising a surface having a plurality of entrapment structures thereon; and
a solid coating layer on the base object, wherein the solid coating layer is within and on the plurality of entrapment structures.

14. The coated object of claim 13, wherein the base object and/or the solid coating layer comprise an elastomeric polymer.

15. The coated object of claim 13, wherein the solid coating layer comprises a pigment, a matting agent, or a combination thereof.

16. (canceled)

17. The coated object of claim 15, wherein the pigment comprises pigment particles having an average diameter of from about 10 or about 20 nanometers to about 0.1, about 0.5, about 1 or about 2 micrometers.

18. The coated object of claim 13, wherein the solid coating layer comprises at least one additive selected from a matting agent, a gloss control agent, a UV blocker, an IR blocker, an optical brightener, an antioxidant, a flow control agent, a dispersant, a thixotropic agent, a dilatant, an adhesion promoter, a slip additive, an anti-slip additive, a texturing additive, an oil resistance additive, a water resistance additive, a chemical resistance additive, an antimicrobial agent, an antibacterial agent, an antiviral agent, a nylon filler, a wax additive, and a combination of two or more of the foregoing.

19. The coated object of claim 13, wherein the solid coating layer comprises a silicone and/or a fluoropolymer.

20. The coated object of claim 13, wherein the plurality of entrapment structures comprise discrete looped structures.

21. The coated object of claim 13, wherein the plurality of entrapment structures comprise connected tunnel structures.

22. The coated object of claim 13, wherein each of the entrapment structures has a void space having a diameter of about 10 μm to about 1500 μm, and the solid coating layer is in the void space.

23. The coated object of claim 13, wherein the solid coating layer is on top surfaces of the plurality of entrapment structures.

24-37. (canceled)
